(19) United States
(12) Patent Application Publication
(10) Pub. No.: US 2007/0080910 A1
(43) Pub. Date: Apr. 12, 2007

(54) Display device with improved image sharpness

(75) Inventors: Kyong-Tae Park, Uijeongbu-si (KR); Si-Duk Sung, Seoul (KR); Nam-Deog Kim, Yongin-si (KR); Chun-Seok Ko, Hwaseong-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/581,158

(22) Filed: Oct. 12, 2006

(30) Foreign Application Priority Data
Oct. 12, 2005 (KR) 10-2005-0096099

(51) Int. Cl. G09G 3/30

(52) U.S. Cl. 345/77

(57) ABSTRACT

A display device that is capable of reducing the blurring of a moving image without decreasing the luminance level is presented. The display device includes a display panel having a plurality of pixels, a scanning driver for supplying scanning signals to the display panel, and a data driver for generating a first data voltage representing higher luminance than a reference luminance and a second data voltage representing lower luminance than the reference luminance and alternately applying the first data voltage and the second data voltage to the display panel. The display device displays an image having different luminance levels between the first sub-frame and the second sub-frame to reduce the blurring.

### CROSS-REFERENCE TO RELATED APPLICATION

This application claims priority to and the benefit of Korean Patent Application No. 10-2005-0096099 filed in the Korean Intellectual Property Office on Oct. 12, 2005, the entire contents of which are incorporated herein by reference.

### BACKGROUND OF THE INVENTION

(a) Field of the Invention

The present invention relates to a display device. More particularly, the present invention relates to a display device having an impulsive effect by displaying images representing higher luminance and images representing lower luminance than a reference luminance during one frame.

(b) Description of the Related Art

Recently, much effort has been dedicated to research on flat panel displays as possible replacements for cathode ray tubes (CRT) as the mainstream display devices. Particularly, organic light emitting diode (OLED) display has shown much promise as a next-generation flat panel display because of its excellent luminance characteristics and viewing angle characteristics.

Generally, an active matrix flat panel display includes a plurality of pixels arranged in a matrix, and it displays images by controlling the luminance of the pixels based on given luminance information. An OLED display is a self-emissive display device that displays images by electrically exciting a light emitting organic material. OLED is particularly advantageous for displaying high-definition motion images because of its low power consumption and fast response time.

An OLED display includes an OLED and a thin film transistor (TFT) for driving the same. The TFTs are divided into poly-silicon TFTs and amorphous silicon TFTs according to the type of the active layer in the TFT. An OLED display employing poly-silicon TFTs is widely used because it has many advantages, but the manufacturing process for this type of TFTs is complicated and accordingly, the manufacturing cost is high. Also, it is difficult for an OLED display with poly-silicon TFTs to have a large screen. On the other hand, an OLED display employing amorphous silicon TFTs is easy to fabricate and can be used in a large screen. Fewer steps are used in the manufacturing process of amorphous silicon TFTs than in the manufacturing process for an OLED display employing poly-silicon TFTs.

On the other hand, since an OLED display is a hold type of display device, blurring of the edges of figures that reduces sharpness occurs when a moving image is displayed.

In order to prevent a blurring phenomenon, use of an OLED display that inserts a black image between an image of one frame and an image of the next frame has been suggested. However, such an OLED display has a problem in that the luminance of the entire screen is reduced by 50% maximally since black images are displayed for a predetermined time during a frame.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a display device that is capable of reducing the blurring of a moving image like the insertion of a black image but without a decrease in luminance level. The invention achieves this goal by displaying images representing higher luminance and images representing lower luminance than a reference luminance during one frame.

In one aspect, the present invention is a display device including a display panel including a plurality of pixels, a scanning driver for supplying scanning signals to the display panel, and a data driver for generating a first data voltage representing higher luminance than a reference luminance and a second data voltage representing lower luminance than the reference luminance and alternately applying the first data voltage and the second data voltage to the display panel.

### BRIEF DESCRIPTION OF THE DRAWINGS

FIG. 1 is a block diagram of an OLED display according to an embodiment of the present invention;

FIG. 2 is an equivalent circuit diagram of a pixel of an OLED display according to an embodiment of the present invention;

FIG. 3 is an exemplary sectional view of an organic light emitting element and a driving transistor of a pixel of an OLED display illustrated in FIG. 2;

FIG. 4 is a schematic diagram of an organic light emitting element of an OLED display according to an embodiment of the present invention;

FIG. 5 is a block diagram illustrating an example of a gray voltage generator of an OLED display illustrated in FIG. 1;

FIG. 6 is a waveform diagram describing an operation of an OLED display according to an embodiment of the present invention;

FIG. 7 is a schematic diagram illustrating images displayed according to the signals illustrated in FIG. 6;

FIG. 8 is a block diagram illustrating a data processor of a signal controller according to another embodiment of the present invention;

FIG. 9 is a graph describing data compression according to another embodiment of the present invention; and

FIG. 10 is a waveform diagram describing an operation of an OLED display according to another embodiment of the present invention.

### DETAILED DESCRIPTION OF THE EMBODIMENTS

An exemplary embodiment of the present invention will hereinafter be described in detail with reference to the accompanying drawings.

The invention provides an OLED display that is capable of inserting a black image between frame images without decreasing the luminance level.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Now, display devices according to embodiments of the present invention will be described in detail with reference to the accompanying drawings.

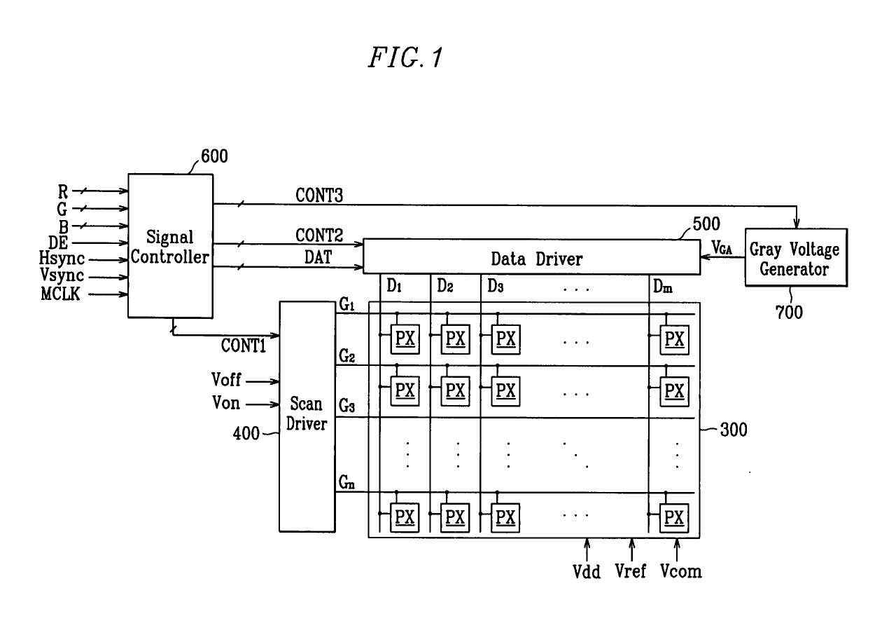

FIG. 1 is a block diagram of an OLED display according to an embodiment of the present invention.

Referring to FIG. 1, an OLED display according to an embodiment of the present invention includes a display panel 300, a scanning driver 400 and a data driver 500 that are connected to the display panel 300, and a gray voltage generator 700. A signal controller 600 controls the above elements.

The display panel 300 includes a plurality of signal lines G₁-Gₙ and D₁-Dₘ, a plurality of voltage lines (not shown), and a plurality of pixels PX connected to the above elements and arranged substantially in a matrix, as seen in the equivalent circuit diagram.

The signal lines G₁-Gₙ and D₁-Dₘ include a plurality of scanning lines G₁-Gₙ for transmitting scanning signals and a plurality of data lines D₁-Dₘ for transmitting data voltages. The scanning lines G₁-Gₙ extend substantially in a first direction and are separated from each other and substantially parallel to each other. The data lines D₁-Dₘ extend substantially in a second direction and are separated from each other and substantially parallel to each other. Each voltage line (not shown) transmits voltages such as a driving voltage Vdd.

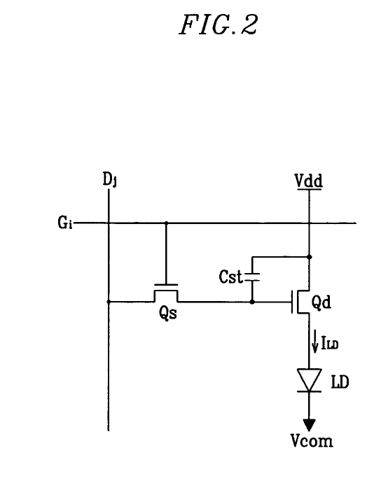

FIG. 2 is an equivalent circuit diagram of a pixel of an OLED display according to an embodiment of the present invention.

Referring to FIG. 2, each pixel of an OLED display according to an embodiment of the present invention includes an organic light emitting element LD, a driving transistor Qd, a capacitor Cst, and a switching transistor Qs.

The driving transistor Qd has an input terminal connected to a driving voltage Vdd and an output terminal connected to an anode electrode of an organic light emitting element LD. Such a driving transistor Qd has a control terminal that is supplied with a data voltage Vdat through a switching transistor Qs, and it applies a driving current I_{LD} to the organic light emitting element LD.

The organic light emitting element LD is a light emitting diode having a light emitting layer. Its anode electrode is connected to the output terminal of a driving transistor Qd, and its cathode electrode is connected to a common voltage Vcom. The organic light emitting element LD is supplied with a driving current I_{LD} from a driving transistor Qd, thereby emitting predetermined light.

The capacitor Cst has an electrode connected to a driving voltage Vdd and another electrode connected to a control terminal of a driving transistor Qd. The capacitor Cst stores electric charges corresponding to the difference between the driving voltage Vdd and the data voltage Vdat. When the switching transistor Qs is turned on, the data voltage Vdat is applied to the capacitor Cst.

The switching transistor Qs has an input terminal connected to a data line Dⱼ, an output terminal connected to a control terminal of the driving transistor Qd, and a control terminal connected to a scanning line Gᵢ. The scanning line Gᵢ is any one of the scanning lines G₁ through Gₙ, and the data line Dⱼ is any one of the data lines D₁ through Dₘ. The switching transistor Qs is turned on by a scanning signal Vgᵢ supplied through the scanning line Gᵢ, and when it is turned on, the switching transistor Qs transmits a data voltage Vdat to the control terminal of a driving transistor Qd and an electrode of the capacitor Cst.

The switching transistor Qs and the driving transistor Qd are n-channel metal oxide semiconductor field effect transistors (MOSFETs) including amorphous silicon or polysilicon. However, the transistors Qs and Qd may be p-channel MOSFETs, and in this case, the operations, voltages, and currents of the p-channel MOSFETs are opposite to those of the n-channel MOSFETs since the p-channel MOSFETs and the n-channel MOSFETs are complementary to each other.

Now, a structure of an organic light emitting element LD and a driving transistor Qd of such an OLED display will be described in detail.

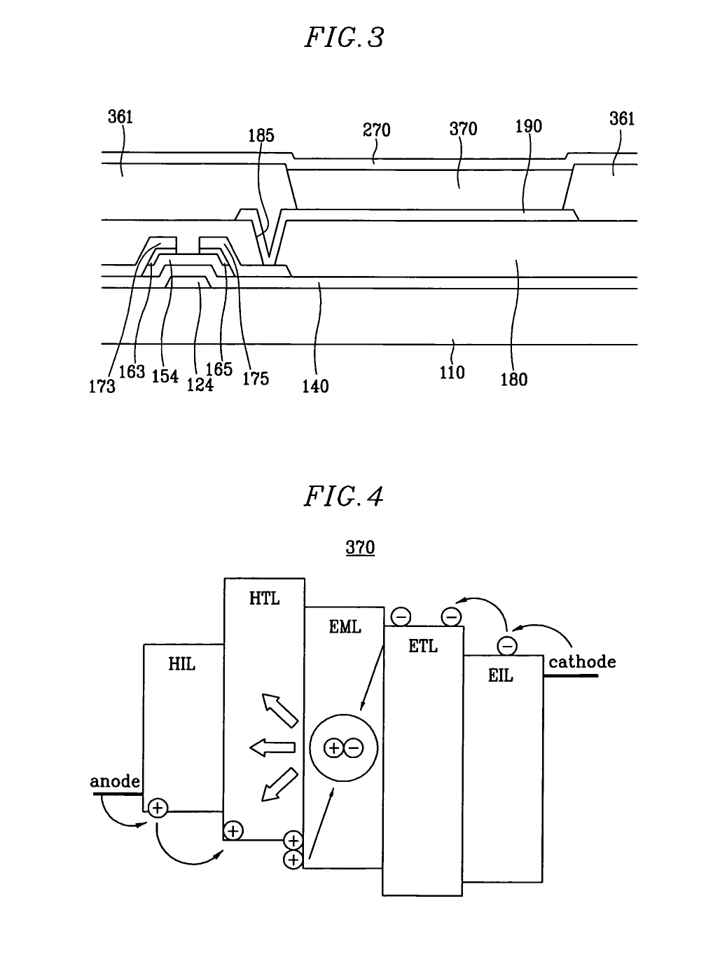

FIG. 3 is a sectional view of an organic light emitting element LD and a driving transistor Qd of a pixel of an OLED display according to an embodiment of the present invention.

In the OLED display, a control electrode 124 is formed on an insulating substrate 110. The control electrode 124 is preferably made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ti, and Ta. In some embodiments, the control electrode 124 may have a multi-layered structure including two conductive films (not shown) having different physical characteristics. In a multi-layered structure, one of the two conductive films is preferably made of a low resistivity metal such as an Al-containing metal, a Ag-containing metal, and a Cu-containing metal for reducing signal delay or voltage drop. The other conductive film is preferably made of a material such as a Mo-containing metal, Cr, Ti, and Ta, which has good physical, chemical, and electrical contact characteristics with other materials such as indium tin oxide (ITO) and indium zinc oxide (IZO). An exemplary multi-layered structure may include a lower Cr film and an upper Al (alloy) film or a lower Al (alloy) film and an upper Mo (alloy) film. These examples are not limiting of the invention and the control electrode 124 may be made of many various metals or conductors. The lateral sides of the control electrode 124 are inclined relative to a surface of the substrate 110, preferably to form inclination angles ranging between about 300 and about 80° with respect to the surface of the substrate 110.

An insulating layer 140 preferably made of silicon nitride (SiNx) is formed on the control electrode 124.

A semiconductor 154 preferably made of hydrogenated amorphous silicon (abbreviated to “a-Si”) or polysilicon is formed on the insulating layer 140. A pair of ohmic contacts 163 and 165 preferably made of silicide or n+ hydrogenated a-Si heavily doped with an n-type impurity are formed on the semiconductor 154. The lateral sides of the semiconductor 154 and the ohmic contacts 163 and 165 are inclined, preferably to form inclination angles a range of about 30° to about 80° with respect to a surface of the substrate 110.

An input electrode 173 and an output electrode 175 are formed on the ohmic contacts 163 and 165 and the insulating layer 140. The input electrode 173 and the output electrode 175 are preferably made of a refractory metal such as Cr, a Mo-containing metal, Ta, and Ti, and may have a multi-layered structure including a refractory metal film (not shown) and a low resistivity film (not shown). An exemplary multi-layered structure may be a double-layered structure including a lower Cr/Mo (alloy) film and an upper Al (alloy) film or a triple-layered structure including a lower Mo (alloy) film, an intermediate Al (alloy) film, and an upper Mo (alloy) film. Like the control electrode 124, the lateral sides of the input electrode 173 and the output electrode 175 are also inclined relative to a surface of the substrate 110, preferably to form inclination angles in the range of about 30° to about 80°.

The input electrode 173 and the output electrode 175 are separated from each other and disposed across the control electrode 124 from each other. The control electrode 124, the input electrode 173, and the output electrode 175, along with the semiconductor 154, form a driving transistor Qd having a channel formed in the semiconductor 154 between the input electrode 173 and the output electrode 175.

The ohmic contacts 163 and 165 are interposed between the underlying semiconductor 154 and the overlying input electrode 173 and the output electrode 175 and reduce the contact resistance between the semiconductor 154 and the input electrode 173/the output electrode 175. A portion of the semiconductor 154 is not covered with the input electrode 173 or the output electrode 175.

A passivation layer 180 is formed on the input electrode 173, the output electrode 175, the exposed portion of the semiconductor 154, and the insulating layer 140. The passivation layer 180 is preferably made of an inorganic insulator such as silicon nitride and silicon oxide, an organic insulator, or a low dielectric insulating material. The low dielectric material has a dielectric constant that is preferably lower than 4.0. Examples of low-dielectric material include a-Si:C:O and a-Si:O:F formed by plasma enhanced chemical vapor deposition (PECVD). The passivation layer 180 may be made of an organic insulator having photosensitivity, and the surface of the passivation layer 180 may be flat. In some embodiments, the passivation layer 180 may have a double-layered structure including a lower inorganic film and an upper organic film so that it takes advantage of the organic film and protects the exposed portions of the semiconductor 154. The passivation layer 180 has a contact hole 185 extending to the output electrode 175.

A pixel electrode 190 is formed on the passivation layer 180. The pixel electrode 190 is physically and electrically connected to the output electrode 175 through the contact hole 185, and it is preferably made of a transparent conductor such as ITO or IZO, or a reflective metal such as an Al or Ag alloy.

A partition 361 is formed on the passivation layer 180. The partition 361 encloses the pixel electrode 190 to define an opening on the pixel electrode 190 like a bank, and it is preferably made of an organic or inorganic insulating material.

An organic light emitting member 370 is formed on the pixel electrode 190, and it is confined in the opening enclosed by the partition 361.

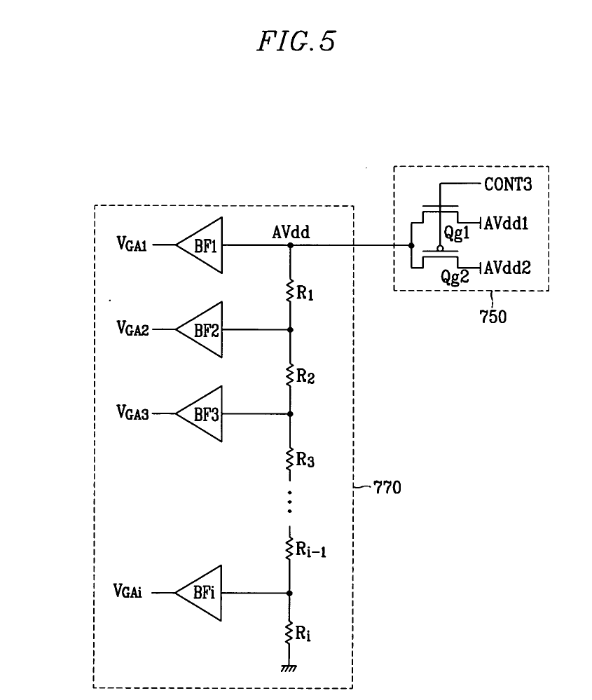

FIG. 4 is a schematic diagram of an organic light emitting element LD of an OLED display according to an embodiment of the present invention.

The organic light emitting member 370, as shown in FIG. 4, has a multi-layered structure including a light emitting layer EML and one or more auxiliary layers for improving the efficiency of light emission for the light emitting layer EML. The auxiliary layers include an electron transport layer ETL and a hole transport layer HTL for improving the balance of electrons and holes, and an electron injecting layer EIL and a hole injecting layer HIL for improving the injection of electrons and holes. The auxiliary layers may be omitted, depending on the embodiment.

A common electrode 270 supplied with a common voltage Vcom is formed on the organic light emitting member 370 and the partition 361. The common electrode 270 is preferably made of a reflective metal such as Ca, Ba, Al, and Ag, or a transparent conductive material such as ITO and IZO.

A combination of opaque pixel electrodes 190 and a transparent common electrode 270 is employed in a top emission type of OLED display that emits light toward the top of the display panel 300, while a combination of transparent pixel electrodes 190 and a opaque common electrode 270 is employed in a bottom emission type of OLED display that emits light toward the bottom of the display panel 300.

A pixel electrode 190, an organic light emitting member 370, and a common electrode 270 form an organic light emitting element LD illustrated in FIG. 2 having the pixel electrode 190 as an anode and the common electrode 270 as a cathode, or vice versa. The organic light emitting element LD emits light of a primary color, wherein the particular color depends on the material contained in the light emitting member 370. An exemplary set of the primary colors includes red, green, and blue. Desired colors are displayed by the spatial sum of the primary colors.

Referring to FIG. 1, the scanning driver 400 is connected to the scanning lines G₁-Gₙ in the display panel 300, and synthesizes a high voltage Von for turning on the switching transistors Qs and a low voltage Voff for turning off the switching transistors Qs to generate scanning signals Vg₁-Vgₙ, which are applied to the scanning lines G₁-Gₙ.

The data driver 500 is connected to the data lines D₁-Dₘ in the display panel 300 and applies data voltages Vdat representing image signals to the data lines D₁-Dₘ.

The gray voltage generator 700 supplied with gray control signals CONT3 from the signal controller 600 generates gray voltages, which are outputted to a digital/analog converter of the data driver 500.

Hereinafter, the gray voltage generator 700 will be further described.

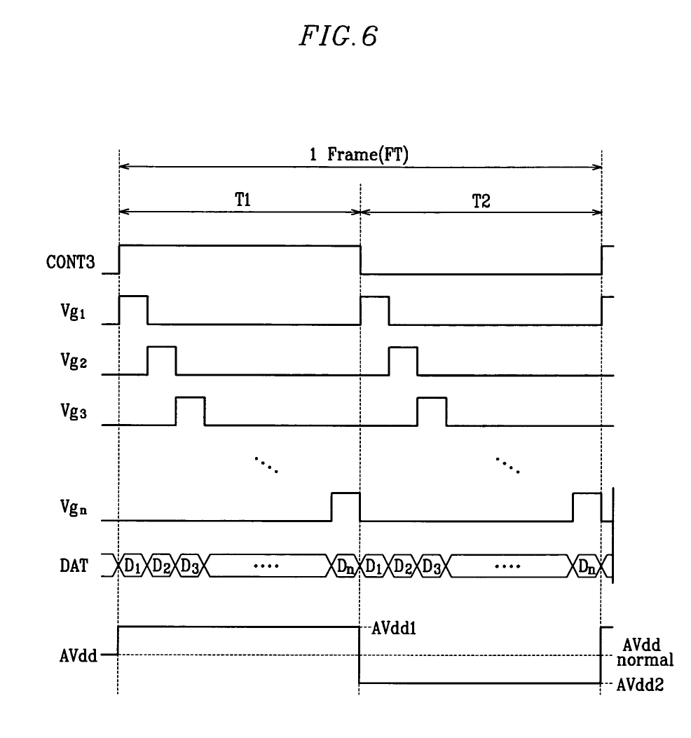

FIG. 5 is a block diagram illustrating an example of a gray voltage generator of the OLED display illustrated in FIG. 1.

Referring to FIG. 5, a gray voltage generator 700 according to an embodiment of the present invention includes a switching unit 750 and an output unit 770.

The switching unit 750 includes two switching transistors Qg1 and Qg2 for selecting one out of two gray reference voltages AVdd1 and AVdd2 that are different from each other.

The first switching transistor Qg1 has an input terminal connected to a first gray reference voltage AVdd1 and an output terminal connected to the output unit 770. The first switching transistor Qg1 is turned on by a gray control signal CONT3 supplied to the control terminal. The first gray reference voltage AVdd1 has a higher level than a reference gray reference voltage corresponding to a reference luminance.

The second switching transistor Qg2 has an input terminal connected to a second gray reference voltage AVdd2 and an output terminal connected to the output unit 770. The second switching transistor Qg2 is turned on by a gray control signal CONT3 supplied to the control terminal. The second gray reference voltage AVdd2 has a lower level than a reference gray reference voltage corresponding to a reference luminance.

Here, conduction types of the first switching transistor Qg1 and the second switching transistor Qg2 are complementary to each other. For example, the second switching transistor Qg2 is a p-type MOSFET and the first switching transistor Qg1 is an n-type MOSFET. Therefore, since the first switching transistor Qg1 and the second switching transistor Qg2 perform on/off operations by the same gray control signals CONT3, the transistors Qg1 and Qg2 operate in a complementary manner.

The output unit 700 includes an array of resistors R1, R2, . . . , Ri connected in series. The first gray reference voltage AVdd1 or the second gray reference voltage AVdd2 is supplied to a first end of the series of resistors in the switching unit 750. The second end of the series of the array of resistors R1, R2, . . . , Ri is at a ground voltage level.

The first or second gray reference voltage AVdd1 or AVdd2 that is applied to the array of resistors R1, R2, . . . , Ri connected in series is divided in proportion to resistance.

The divided voltages are set at the respective nodes between the resistors, and the voltages at each node become the gray voltages V_{GA1}, V_{GA2}, . . . , V_{GAi} of the data driver 500. These gray voltages V_{GA1}, V_{GA2}, . . . , V_{GAi} are supplied to the digital/analog converter of the data driver 500 as reference voltages, and complement the linearity of the relationship between the driving current I_{LD} supplied to the organic light emitting element LD and luminance and the relationship between the data voltage Vdat and the driving current I_{LD}. The gray voltages V_{GA1}, V_{GA2}, . . . , V_{GAi} set at the nodes of the array of resistors R1, R2, . . . , Ri may be supplied to the data driver 500 through buffers BF1, BF2, BF3, . . . , BFi.

The scanning driver 400, the data driver 500, and the gray voltage generator 700 may be implemented as a plurality of driving integrated circuit chips directly mounted on the display panel 300, or they may be mounted on a flexible printed circuit film (not shown) in a tape carrier package (TCP) type which is attached to the display panel 300. Alternately, the scanning driver 400, the data driver 500, or the gray voltage generator 700 may be formed on the display panel 300 along with the signal lines and the transistors to embody a system-on-panel (SOP).

The signal controller 600 controls the operation of the scanning driver 400, the data driver 500, and the gray voltage generator 700.

Hereinafter, operation of an OLED display will be described in detail.

FIG. 6 is a waveform diagram describing an operation of an OLED display according to an embodiment of the present invention.

Referring to FIG. 6, the signal controller 600 is supplied with input image signals R, G, and B and input control signals for controlling the display, such as a vertical synchronization signal Vsync, a horizontal synchronization signal Hsync, a main clock signal MCLK, and a data enable signal DE, from an external graphics controller (not shown). The signal controller 600 processes the input image signals R, G, and B suitably for the operating conditions of the display panel 300 using the input image signals R, G, and B and the input control signals, and generates scanning control signals CONT1, data control signals CONT2, and gray control signals CONT3. Then, the signal controller 600 transmits the generated scanning control signals CONT1 to the scanning driver 400, the data control signals CONT2 and the processed image data DAT to the data driver 500, and the gray control signals CONT3 to the gray voltage generator 700.

The scanning control signals CONT1 include a vertical synchronization start signal STV for instructing the start of high voltage scanning and at least one clock signal for controlling the output of the high voltage Von. The scanning control signals CONT1 may further include an output enable signal OE for defining the duration of the high voltage Von.

The data control signals CONT2 include a horizontal synchronization start signal STH for informing the start of data transmission for a row of pixels PX, a load signal LOAD for instructing to apply the corresponding data voltages Vdat to the data lines D₁-Dₘ, and a data clock signal HCLK.

The gray control signal CONT3 includes a control signal for selecting the first gray reference voltage AVdd1 or the second gray reference voltage AVdd2. The control signal has an amplitude having a width from a low voltage Voff that can turn on a p-type MOSFET to a high voltage Von that can turn on an n-type MOSFET. The gray control signal CONT3 may further include an enable signal for defining the duration of the high voltage Von.

In a first sub-frame T1, the gray control signal CONT3 at a high level is supplied by the signal controller 600 to the gray voltage generator 700, thereby turning on the first switching transistor Qg1 of the switching unit 750. Then, a first gray reference voltage AVdd1 is supplied to the top node of the output unit 770, and gray voltages VGA1, VGA2, . . . , V_{GAi} divided by the array of resistors R1, R2, . . . , Ri are supplied to the digital/analog converter of the data driver 500 through the buffers.

In response to the data control signals CONT2 from the signal controller 600, the data driver 500 converts the digital image data DAT representing each specific gray into analog data voltages Vdat. Here, since the gray voltages V_{GA1}, V_{GA2}, . . . , V_{GAi} from the gray voltage generator 700 are supplied as reference voltages of the digital/analog converter, the converted analog data voltage Vdat is higher than a reference data voltage corresponding to a specific gray.

The scanning driver 400 is supplied with a vertical synchronization start signal STV and a clock signal from the signal controller 600, and outputs a first scanning signal Vg₁ that maintains a high level during one clock period.

The switching transistor Qs is turned on when the scanning signal Vg₁ at a high level is supplied from the scanning driver 400.

The driving transistor Qd that is supplied with an analog data voltage Vdat through the turned on switching transistor Qs outputs a driving current I_{LD} to the organic light emitting element LD. The driving current I_{LD} is adjusted according to the analog data voltage Vdat. Then, the organic light emitting element LD emits light corresponding to the supplied driving current I_{LD}. Since the analog data voltage Vdat has a higher value than a reference data voltage corresponding to a specific gray, the luminance of the emitted light is greater than a reference luminance corresponding to a specific gray. The operation as mentioned above is performed sequentially up to the pixels PX in the n-th row, thereby displaying an image.

A second sub-frame T2 starts when the gray control signal CONT3 changes to a low level. The second switching transistor Qg2 of the switching unit 750 is turned on when the gray control signal CONT3 at a low level is supplied to the gray voltage generator 700. Then, a second gray reference voltage AVdd2 is supplied to the top node of the output unit 770, and gray voltages V_{GA1}, V_{GA2}, . . . , V_{GAi} divided by the array of resistors R1, R2, . . . , Ri are supplied to the data driver 500 through the buffers.

The data driver 500 converts the digital image data DAT received from the signal controller 600 into analog data voltages Vdat. The values of the digital image data DAT are equal to the values of the digital image data DAT of the first sub-frame T1. Since the gray voltages V_{GA1}, V_{GA2}, . . . , V_{GAi} are supplied as reference voltages of the digital/analog converter, an analog data voltage Vdat that is lower than the reference data voltage corresponding to the gray of the digital image data DAT is outputted to the corresponding data line D1.

When the scanning signal Vgᵢ at a high level is supplied from the scanning driver 400, the switching transistor Qs is turned on and a driving current I_{LD} corresponding to the analog data voltage Vdat flows from the driving transistor Qd to the organic light emitting element LD through the turned on switching transistor Qs. Then, the organic light emitting element LD emits light corresponding to the supplied driving current I_{LD}. Here, since the analog data voltage Vdat has a lower value than the reference data voltage corresponding to the gray of the digital image data DAT, the luminance of the emitted light is lower than the reference luminance of the corresponding gray. Therefore, the luminance of the displayed image in the second sub-frame T2 is remarkably lower than that in the first sub-frame T1, while the image in the second sub-frame T2 is identical with that in the first sub-frame T1.

Therefore, if an image having higher luminance than the reference luminance is displayed in the first sub-frame T1 of the next frame, the blurring of the moving image can be reduced between the current frame and the next frame by using a luminance difference between the second sub-frame T2 of the current frame and the first sub-frame T1 of the next frame. Unlike the insertion of the black image, this method does not decrease the luminance level because black images are not displayed while applying this method.

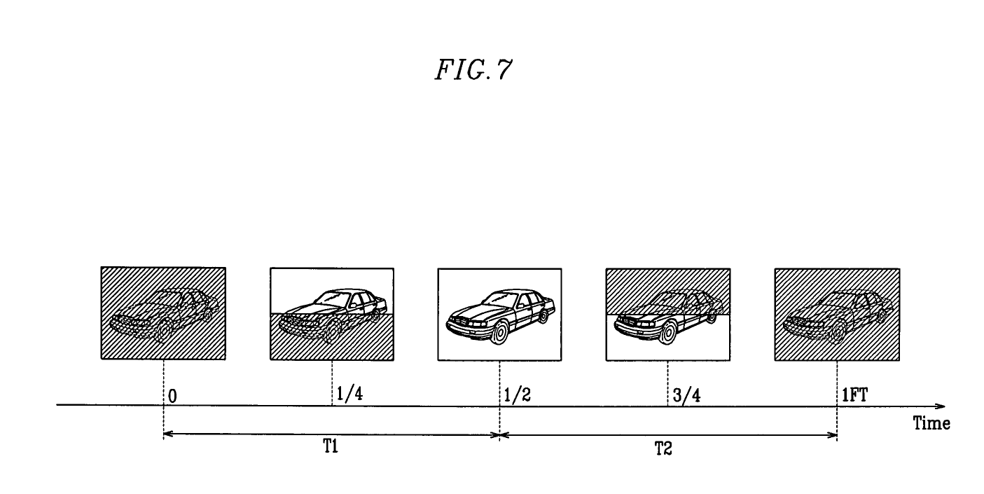

FIG. 7 is a schematic diagram illustrating images displayed according to the signals illustrated in FIG. 6.

Referring to FIG. 7, a dark image of the previous frame that has lower luminance than a reference luminance corresponding to the gray is displayed in the initial screen of a frame. When the first sub-frame T1 starts, a bright image of the current frame that has higher luminance than a reference luminance corresponding to the gray is displayed at the top of the screen. Then, about half-way through the frame (i.e., at ½ FT in FIG. 7), a bright image of the current frame is displayed over the entire screen.

When the second sub-frame T2 starts, a dark image of the current frame that has lower luminance than a reference luminance corresponding to the gray is displayed from the top of the screen. Since the image recorded in the digital image data DAT is identical to the image of the first sub-frame T1, the image of the second sub-frame T2 is the same as that of the first sub-frame T1 except for the luminance level. A dark image is displayed over the entire screen at the end of the current frame (i.e., at 1FT in FIG. 7).

Pixels PX emit light more during a half of one frame 1FT and less during the other half of one frame depending on the supplied data voltages Vdat, thereby preventing blurring of the images and loss of sharpness without decreasing the overall luminance.

Now, an OLED display for generating a voltage change based on luminance difference to maintain a desired luminance level according to another embodiment of the present invention will be described.

This embodiment of the present invention, like the OLED display illustrated in FIG. 1, includes the display panel 300, the scanning driver 400, the data driver 500, and the gray voltage generator 700 that are controlled by the signal controller 600. The display panel 300, the scanning driver 400, and the data driver 500 are substantially the same as in the embodiment of FIG. 1, and their description will not be repeated.

The gray reference voltage of the gray voltage generator 700 is at a higher level than a reference voltage corresponding to a reference luminance. Therefore, the gray voltages V_{GA1}, V_{GA2}, . . . , V_{GAi} supplied to the data driver 500 also have a higher level than a reference voltage corresponding to the reference luminance.

The signal controller 600 receives input image signals R, G, and B and input control signals for controlling the display, such as a vertical synchronization signal Vsync, a horizontal synchronization signal Hsync, a main clock signal MCLK, and a data enable signal DE, from an external graphics controller (not shown). The signal controller 600 processes the input image signals R, G, and B suitably for the operation condition of the display panel 300 using the input image signals R, G, and B and the input control signals, and generates scanning control signals CONT1, data control signals CONT2, and gray control signals CONT3. Then, the signal controller 600 transmits the scanning control signals CONT1 to the scanning driver 400 and the gray control signals CONT3 to the gray voltage generator 700, respectively, and transmits the data control signals CONT2 and the processed image data DAT to the data driver 500.

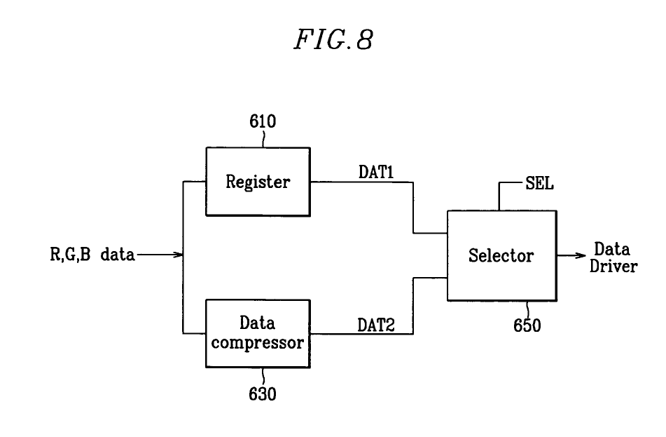

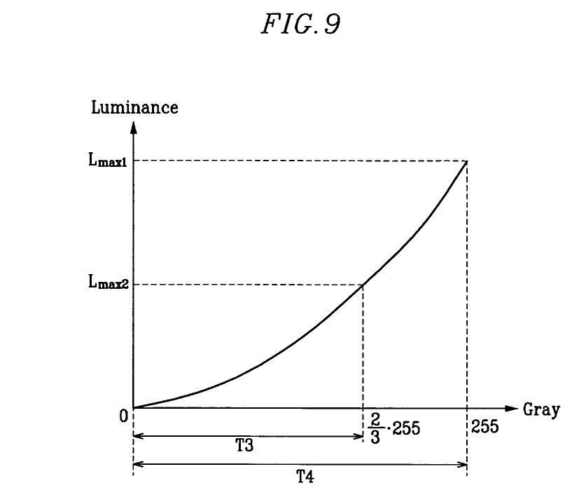

FIG. 8 is a block diagram illustrating a data processor of a signal controller according to another embodiment of the present invention.

Referring to FIG. 8, a data processor of a signal controller according to another embodiment of the present invention includes a register 610, a data compressor 630, and a selector 650.

The register 610 receives input image signals R, G, and B for one frame from an external graphics controller (not shown), signal processes the input images signals R, G, B to generate image data DAT1, and stores the general image data DAT1. The general image DAT1 corresponds to the grays and outputs the general image data DAT1 to the data driver 500 in response to the input control signals.

The data compressor 630 compresses the input image signals R, G, and B supplied from an external graphics controller (not shown) in a predetermined ratio, and then outputs the compressed image data DAT2 to the data driver 500 in response to the input control signals.

FIG. 9 is a graph describing data compression according to another embodiment of the present invention.

In a case where the bit number of the general image data DAT1 supplied to the data driver 500 is eight, pixels PX can represent grays of 256 (2⁸) levels.

When the compression ratio of the data compressor 630 is 2:3, the data compressor 630 generates compressed image data DAT2 having a gray level that is ⅔ of the gray level of the general image data DAT1. That is, compressed image data DAT2 having a gray level of 0 is generated if the gray level of the general image data DAT1 is 0, and compressed image data DAT2 having a gray level of 1 is generated if the gray level of the general image data DAT1 is 1 or 2. Compressed image data DAT2 having a gray level of 2 is generated if the gray level of the general image data DAT1 is 3, and compressed image data DAT2 having a gray level of 3 is generated if the gray level of the general image data DAT1 is 4 or 5.

By repeating this operation, the general image data DAT1 having 256 gray levels is converted into compressed image data DAT2 having 256(⅔) gray levels. Therefore, if the general image data DAT1 represents the highest level of gray 256, the data compressor 630 converts the general image data DAT1 into compressed image data DAT2 having a 256(⅔) gray levels. The compressed image data DAT2 is outputted to the data driver 500. Then, the data driver 500 converts the compressed image data DAT2 into an analog data voltage Vdat, which is supplied to a pixel PX. Thus, the pixel PX emits light having luminance L_{MAX2} of a 256(⅔) gray-level-scale, not luminance L_{MAX1} of a 256 gray-level-scale.

When the compression ratio of the data compressor 630 is 1:2, the data compressor 630 generates compressed image data DAT2 having a gray level that is about half of the gray level of the general image data DAT1. That is, compressed image data DAT2 having a gray level of 0 is generated if the gray level of the general image data DAT1 is 0 or 1, and compressed image data DAT2 having a gray level of 1 is generated if the gray level of the general image data DAT1 is 2 or 3. Next, compressed image data DAT2 having a gray level of 2 is generated if the gray level of the general image data DAT1 is 4 or 5.

By repeating this operation, the general image data DAT1 having 256 gray levels is converted into compressed image data DAT2 having 256(½) gray levels.

The data processor includes a selector 650 for outputting image data DAT1 or DAT2 from the register 610 or the data compressor 630 to the data driver 500, selectively.

The selector 650 receives the general image data DAT1 and the compressed image data DAT2 from the register 610 and the data compressor 630, respectively. The selector 650 selectively outputs one of the two image data DAT1, DAT2 to the data driver 500 in response to a selecting signal SEL from the signal controller 600.

Then, operation of an OLED according to another embodiment of the present invention will be described in detail.

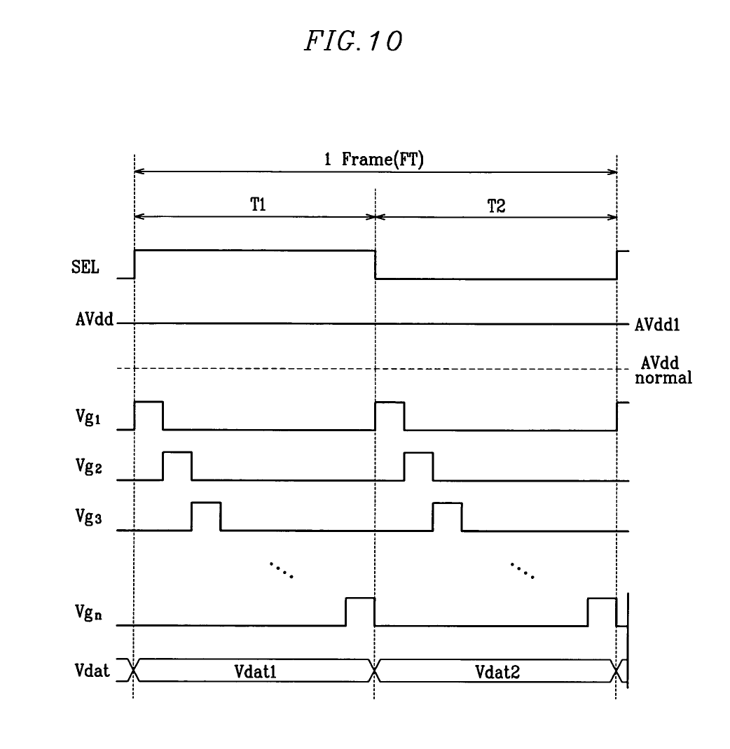

FIG. 10 is a waveform diagram describing an operation of an OLED display according to another embodiment of the present invention.

This embodiment will be described with the assumption that the compression ratio of the data compressor 630 is 2:3.

When input image signals R, G, and B from an external graphics controller (not shown) are supplied to the register 610 and the data compressor 630, the register 610 signal processes them to generate general image data DAT1, and the data compressor 630 generates compressed image data DAT2 that are compressed by 2:3 ratio. As a selecting signal SEL at a high level is supplied to the selector 650, a first sub-frame T1 starts.

The selector 650 outputs the general image data DAT1 from the register 610 to the data driver 500 in response to the selecting signal SEL at a high level.

The data driver 500 is supplied with the general image data DAT1, data control signals CONT2, and gray voltages V_{GA1}, V_{GA2}, . . . , V_{GAi} from the gray voltage generator 700, and then converts the general image data DAT1 into predetermined analog data voltages Vdat1, which are outputted to the data line Dj.

The scanning driver 400 that is supplied with scanning control signals CONT1 from the signal controller 600 outputs a first scanning signal Vg₁ to a first scanning line G₁.

The switching transistor Qs is turned on when the first scanning signal Vg₁ at a high level is supplied from the scanning driver 400, thereby applying the analog data voltage Vdat1 to the control terminal of the driving transistor Qd. The driving transistor Qd outputs a driving current I_{LD} corresponding to the analog data voltage Vdat1 to the organic light emitting element LD. Then, the organic light emitting element LD emits light corresponding to the supplied driving current I_{LD}. Here, since the analog data voltage Vdat1 has a higher value than a reference data voltage corresponding to a specific gray based on the high gray reference voltage, the luminance of the emitted light is greater than the reference luminance corresponding to the specific gray. The operation as mentioned above is performed sequentially up to the pixels PX in the n-th row, thereby displaying an image.

The second sub-frame T2 starts when a selecting signal SEL at a low level is supplied to the selector 650 of the data processor. The selector 650 outputs the compressed image data DAT2 from the data compressor 630 to the data driver 500 in response to the selecting signal SEL at a low level.

The data driver 500 is supplied with the compressed image data DAT2, data control signals CONT2, and gray voltages V_{GA1}, V_{GA2}, . . . , V_{GAi} from the gray voltage generator 700, and then converts the compressed image data DAT2 into predetermined analog data voltages Vdat2, which are outputted to the data line Dj.

The switching transistor Qs is turned on when the scanning signal Vgᵢ at a high level is supplied from the scanning driver 400, thereby applying the analog data voltage Vdat2 to the control terminal of the driving transistor Qd. Then, the driving transistor Qd outputs a driving current I_{LD} corresponding to the analog data voltage Vdat2 to the organic light emitting element LD, and then the organic light emitting element LD emits light corresponding to the supplied driving current I_{LD}. Here, the analog data voltage Vdat2 has a lower level than the analog data voltage Vdat1 of the general image data DAT1 since it is the converted analog value of the compressed image data DAT2. Therefore, the luminance of the displayed image in the second sub-frame T2 is lower than that in the first subframe T1, while the image in the second subframe T4 is identical with that in the first sub-frame T1.

As mentioned above, according to the present invention, the same image of different luminance levels can be displayed in one frame by using different luminance levels between the first sub-frame and the second sub-frame. Any decrease in luminance level can be prevented since images having higher luminance and lower luminance than a reference luminance are alternately displayed during one frame.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display panel including a plurality of pixels;
a scanning driver for supplying scanning signals to the display panel; and
a data driver for generating a first data voltage representing higher luminance than a reference luminance and a second data voltage representing lower luminance than the reference luminance and alternately applying the first data voltage and the second data voltage to the display panel.

2. The display device of claim 1, further comprising a gray voltage generator for generating a first set of gray voltages based on a first gray reference voltage and a second set of gray voltages based on a second gray reference voltage and outputting the first set of gray voltages and the second set of gray voltages to the data driver.

3. The display device of claim 2, wherein the gray voltage generator comprises:
a switching unit for selecting one of the first gray reference voltage and the second reference voltage in response to a control signal; and
an output unit for dividing the selected one of the first gray reference voltage and the second gray reference voltage and generating the first set of gray voltages or the second set of gray voltages.

4. The display device of claim 3, wherein the switching unit comprises:
a first switching transistor for transmitting the first gray reference voltage to the output unit in response to the control signal; and
a second switching transistor for transmitting the second gray reference voltage to the output unit in response to the control signal,
wherein the first switching transistor and the second switching transistor are alternately turned on and off.

5. The display device of claim 4, wherein the data driver receives same image data twice and converts the same image data into the first data voltage one time and into the second data voltage another time.

6. The display device of claim 1, further comprising a signal controller including a data processor that alternately supplies general image data and compressed image data to the data driver.

7. The display device of claim 6, wherein the data processor comprises:
a register for storing the general image data;
a data compressor for compressing the general image data to generate the compressed image data; and
a selector for selecting one out of the general image data of the register and the compressed image data of the data compressor in response to a selecting signal to be outputted to the data driver.

8. The display device of claim 7, wherein the number of gray levels in the compressed image data is ½ or ⅔ of the number of gray levels in the general image data.

9. The display device of claim 8, wherein the compressed image data has lower gray levels among the set of gray levels that the general image data has.

10. The display device of claim 9, further comprising a gray voltage generator for supplying gray voltages to the data driver.

11. The display device of claim 10, wherein the gray voltage generator divides a gray reference voltage to generate the gray voltages.
